(19) United States
(12) Patent Application Publication
(10) Pub. No.: US 2026/0222964 A1
(43) Pub. Date: Jul. 30, 2026

(54) METHOD FOR ROUTING MESSAGES IN A MESH NETWORK

(71) Applicant: Orange, Issy-Les-Moulineaux (FR)

(72) Inventors: Philippe SURBAYROLE, Chatillon Cedex (FR); Apostolos KOUNTOURIS, Chatillon Cedex (FR)

(21) Appl. No.: 19/143,357

(22) PCT Filed: Dec. 20, 2023
(86) PCT No.: PCT/EP2023/086937

§ 371 Date: Jun. 25, 2025

(30) Foreign Application Priority Data
Dec. 26, 2022 (FR) 2214496

(51) Int. Cl. H04W 40/20

(52) U.S. Cl. CPC H04W 40/20

(57) ABSTRACT

This disclosure relates to a routing method for routing a message (3) via nodes (2) of a network (1), wherein the message (3) comprises geographical destination data, and the method, carried out by a current node of the network (1), comprises: upon receiving a message comprising said geographical destination data, and coming from a sending node, deciding whether or not to transmit the message on the basis of a desired direction of transmission of the message, determined on the basis of the geographical destination data and of a direction taken by the message between the sending node and the current node.

### CROSS-REFERENCE TO RELATED APPLICATIONS

This application is filed under 35 U.S.C. § 371 as the U.S. National Phase of Application No. PCT/EP2023/086937 entitled “METHOD FOR ROUTING MESSAGES IN A MESH NETWORK” and filed Dec. 20, 2023, and which claims priority to FR2214496 filed Dec. 26, 2022, each of which is incorporated by reference in its entirety.

### BACKGROUND

### Field

This disclosure relates to the field of message routing in a network, and in particular to message routing in a mesh network which makes use of a flooding transmission mode.

### Description of the Related Technology

In IoT (Internet of Things) networks, it is known to use mesh networks. In a mesh network, nodes are connected peer-to-peer without a central hierarchy, and each node can receive, send, and retransmit a message. The implementation of a mesh network makes it possible to increase network robustness by avoiding sensitive points where network operation may be disrupted in the event of a failure. Indeed, in a mesh network, if a node fails, the message can be transmitted via an alternative route.

Within such a mesh network, messages can be transmitted in flooding mode. Flooding involves flooding the network with messages in the hope that they will arrive at their destination. This technique can be used for message routing or for route discovery within the network, for example using the AODV (Ad hoc On Demand Distance Vector) protocol. This network flooding technique eliminates the need to maintain routing tables and allows for responsiveness to changes in network architecture, such as the addition of a new node, the use of mobile nodes, or in the event of a failure and/or attack.

However, in a mesh network, the flooding transmission mode has the disadvantage of encouraging network congestion and can have a significant energy impact. Routing methods are sought that are less energy-intensive and that reduce the risk of network saturation.

### SUMMARY

This disclosure improves the situation.

A routing method is proposed for routing a message via nodes of a network, wherein the message comprises geographical destination data, and the method, implemented by a current node of the network, comprises:
upon receiving a message comprising said geographical destination data, and coming from a sending node,
deciding whether or not to transmit the message on the basis of a desired direction of transmission of the message, determined on the basis of the geographical destination data and of a direction taken by the message between the sending node and the current node.

### Method for Routing Messages in a Mesh Network

“Geographical destination data” is understood to mean data which allows defining the spatial location of a destination of the message. “Direction” is understood to mean a spatial direction between the relevant geographical locations.

The use of geographical destination data advantageously allows a geographic routing of messages. The method according to this disclosure advantageously allows retransmitting only those messages which are spatially oriented towards the destination. This improves the security of message transmission because messages are transmitted more selectively towards the destination. Indeed, the fact that messages are not broadcast unnecessarily, particularly in the wrong directions, makes it possible to improve the security of message transmission. In addition, the method allows limiting the number of message retransmissions before reaching the destination. This makes it possible, on the one hand, to limit network saturation by reducing the ripple effect, and on the other hand, to limit consumption by the various network elements and therefore to reduce the energy impact of message transmission.

A geographical location is associated with each of the nodes. Each of the nodes in the network knows its geographical location, determined by the node itself or transmitted by the network. The geographical location of each node may, in particular, comprise spatial coordinates of a point associated with the node, for example a set of three-dimensional coordinates of said point. Each of the sets of three-dimensional coordinates may be associated with a radius of uncertainty around this point. Each of the nodes may comprise means of determining its location, for example means of geolocation such as triangulation.

The features set forth in the following paragraphs may optionally be implemented, independently of one another or in combination with one another:

The geographical destination data may comprise a destination point having spatial coordinates, possibly with an associated tolerance radius. The destination node(s) then correspond to the nodes located within the tolerance radius around the destination point.

Advantageously, the method comprises:
determining the desired direction of transmission of the message, which comprises determining a destination vector that is collinear with the direction connecting the geographical location of the current node and the geographical destination,
determining the direction taken by the message, which comprises obtaining an arrival vector that is collinear with the direction connecting the geographical location of the current node and the geographical location of the sending node.

Advantageously, deciding whether or not to transmit the message comprises: comparing a retransmission angle determined as a function of the arrival vector and the destination vector, with a routing angle.

The routing angle may be fixed or may be adapted according to the network topology, for example according to the extent and/or density of the network.

Optionally, the routing angle is constant data.

Optionally, the routing angle is data that can be determined as a function of at least one routing parameter carried by the message. This feature allows placing further constraints on the transmission of the message as it progresses through the network. In other words, the message is transmitted in an increasingly selective manner as it approaches the destination. Optionally, the message may carry the geographical location of the sending node.

Optionally, the message carries an address of the sending node and the current node comprises a table, referred to as the neighbour table, which lists neighbour nodes of the current node, each neighbour node being identified by an address and each neighbour node being associated with data relating to the geographical location of that neighbour node. The term “neighbour nodes” is understood to mean nodes that can communicate directly with the current node. The arrival vector is obtained on the basis of the neighbour table when the address of the sending node is present in the neighbour table. The neighbour table advantageously makes it possible to construct a topology for message routing through a current node, which is a function of the neighbour nodes of this current node. In particular, the term “routing topology” is understood to mean the set of admissible directions for retransmission of a message by the current node according to the geographical position of the neighbour nodes of the current node.

The data relating to the geographical location of the respective neighbour node may consist of a geographical location of the neighbour node, or alternatively may correspond to a vector that is collinear with the direction connecting the geographical location of the current node and the geographical location of the neighbour node. Storing said vector associated with the neighbour node advantageously makes it possible to avoid calculating the vector between the sending node and the current node upon each new transmission of a message.

Advantageously, the sending node is the last node to have transmitted the message to the current node. The term “last node to have transmitted the message to the current node” is understood to mean the node that last transmitted the message to the current node in a message transmission chain.

Advantageously, the message comprises a number of hops, and the decision on whether or not to transmit the message is further made based on the number of hops.

When the message comprises a number of hops, the method may advantageously be implemented once the number of hops of the message reaches a predetermined number of hops since the first transmission of the message, for example two hops. In other words, the method further comprises, upon reception of the message and prior to implementing the transmission of the message, verifying the number of hops made by the message prior to reception of the message by the current node. When the number of hops made is equal to a predetermined number of hops, transmission of the message according to the method of this disclosure is implemented. This makes it possible to avoid being too restrictive at the initial transmission of the message and to be able, for example, to circumvent potential obstacles.

The message may advantageously comprise an age, and the decision on whether or not to transmit the message is made based on the age of the message.

According to another aspect, a node of a network for the method as described above is provided.

According to another aspect, a computer program is provided comprising instructions for implementing all or part of a method as defined herein when this program is executed by a processor. According to another aspect, a non-transitory, computer-readable storage medium is provided on which such a program is stored.

### BRIEF DESCRIPTION OF THE DRAWINGS

Other features, details and advantages will become apparent from reading the detailed description below, and from analyzing the attached drawings, in which:

FIG. 1 shows an example of a network of nodes for implementing the above method, according to one embodiment.

FIG. 2 shows an example of steps of the method as defined above, according to one embodiment.

FIG. 3 shows an example of steps of the method as defined above, according to one embodiment.

FIG. 4 illustrates two examples, A and B, of the routing topology of a current node for implementing the above method, according to one embodiment.

FIG. 5 shows an example of steps of the method as defined above, according to one embodiment.

FIG. 6 schematically illustrates a node according to one embodiment.

### DETAILED DESCRIPTION OF CERTAIN ILLUSTRATIVE EMBODIMENTS

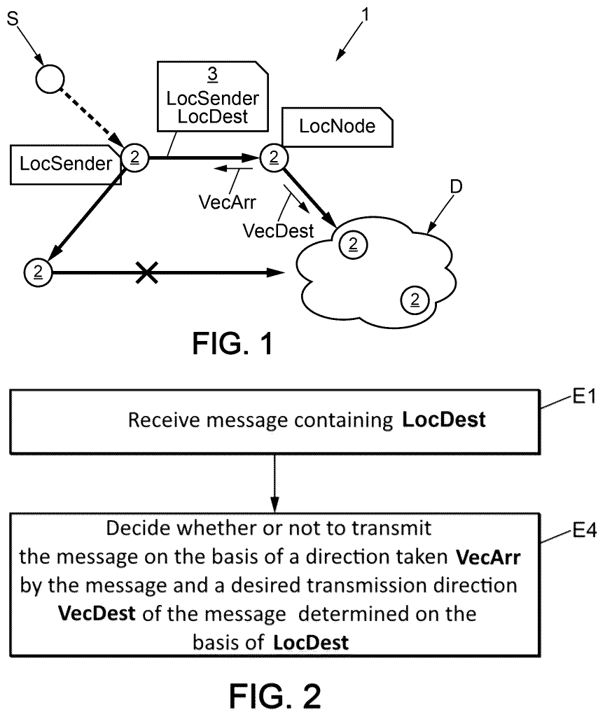

Reference is now made to FIG. 1 which schematically shows a network 1 having nodes 2, also conventionally referred to as “hosts”. Of particular interest is the routing of messages in such a network 1. A geographical location is associated with each of the nodes. Each of the nodes in the network knows its geographical location. The geographical location of each of the nodes may comprise spatial coordinates of a point associated with the node, for example a set of three-dimensional coordinates of said point. Each of the sets of three-dimensional coordinates may be associated with a radius of uncertainty around this point. Each of the nodes may comprise means of determining its location, for example means of geolocation such as triangulation.

According to one aspect, this disclosure relates to a routing method for routing a message, also referred to as a packet, via nodes of the network. The message comprises geographical destination data LocDest. The message is conventionally composed of “payload” data corresponding to the content of the message to be transmitted, and “routing data” which allows managing the routing of the message in the network. Of particular interest here is the message's routing data, comprising the geographical destination data LocDest.

More precisely, the message is routed from a source S to a destination D. The “source” of the message may correspond to a network node, or to an entity connected to one of the network nodes and requesting that said node transmit the message. For example, a user may connect to a node through a smart phone interface. “Destination” is understood to mean a geographical destination represented by the geographical destination data, and which may cover one or more destination nodes. The geographical destination data may comprise a destination point having spatial coordinates, possibly with an associated tolerance radius. The destination node(s) then correspond to the nodes located within the tolerance radius around the destination point. The use of geographical destination data advantageously allows a geographic routing of messages. “Geographic routing” is understood to mean a routing of messages within a three-dimensional space.

FIG. 2 shows a schematic diagram of the method implemented by a current node of the network. The method comprises:
upon receiving E1 a message comprising said geographical destination data LocDest, and coming from a sending node,
deciding E4 whether or not to transmit the message on the basis of a desired direction of transmission of the message, determined on the basis of the geographical destination data LocDest and of a direction taken by the message between the sending node and the current node.

“Direction” is understood to mean a spatial direction between the geographical locations concerned.

The method according to this disclosure advantageously allows retransmitting only those messages which are spatially oriented towards the destination. This improves the security of message transmission because the messages are transmitted more selectively towards the destination. Indeed, the fact that messages are not broadcast unnecessarily, particularly in the wrong directions, makes it possible to improve the security of message transmission. In addition, the method allows limiting the number of message retransmissions before reaching the destination. This makes it possible, on the one hand, to limit network saturation by reducing the ripple effect, and on the other hand, to limit consumption by the various network elements and therefore to reduce the energy impact of message transmission.

The determination of the direction taken and of the desired direction may be performed directly by the current node, or alternatively by a computer with which the current node can communicate for example.

The sending node is preferably the last node to have transmitted the message to the current node. The term “last node to have transmitted the message to the current node” is understood to mean the node that last transmitted the message to the current node in a message transmission chain. Alternatively, the sending node may correspond to a node that sent the message to the current node via at least one other node. The sending node may, for example, correspond to a source node of the message. One may note that the further upstream the sending node is in the message transmission chain, the more precise the estimation of the direction taken will be. However, using the last node to transmit the message, as the sending node, is a pragmatic solution that is simple to implement.

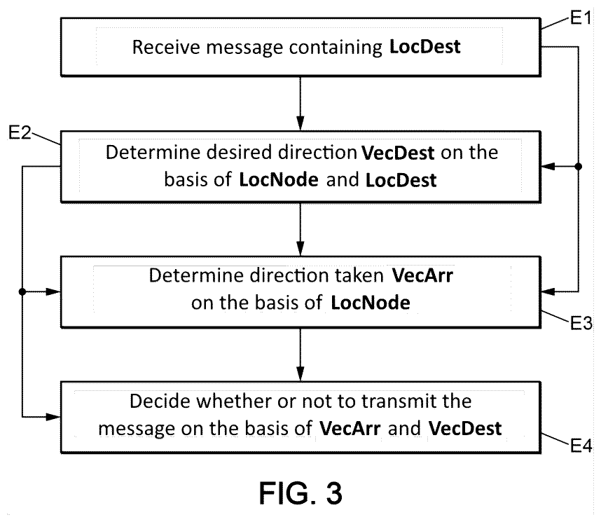

Furthermore, with reference to FIG. 3, the method advantageously comprises:
determining E2 the desired direction of transmission of the message,
determining E3 the direction taken by the message.

With reference to FIG. 1, determining the desired direction of transmission of the message may comprise determining a destination vector VecDest as a function of the geographical location LocNode of the current node and of the geographical destination LocDest. The destination vector VecDest is in particular determined so as to be collinear with the direction connecting the geographical location LocNode of the current node and the geographical destination LocDest.

The direction taken by the message between the sending node and the current node is in particular determined based on the geographical location LocSender of the sending node and on the geographical location LocNode of the current node. More specifically, determining the direction taken by the message may comprise obtaining an arrival vector VecArr that is collinear with the direction connecting the geographical location LocNode of the current node and the geographical location LocSender of the sending node.

To this end, the message may carry the geographical location LocSender of the sending node. Said arrival vector VecArr may be calculated each time a message is transmitted to the current node by a sending node.

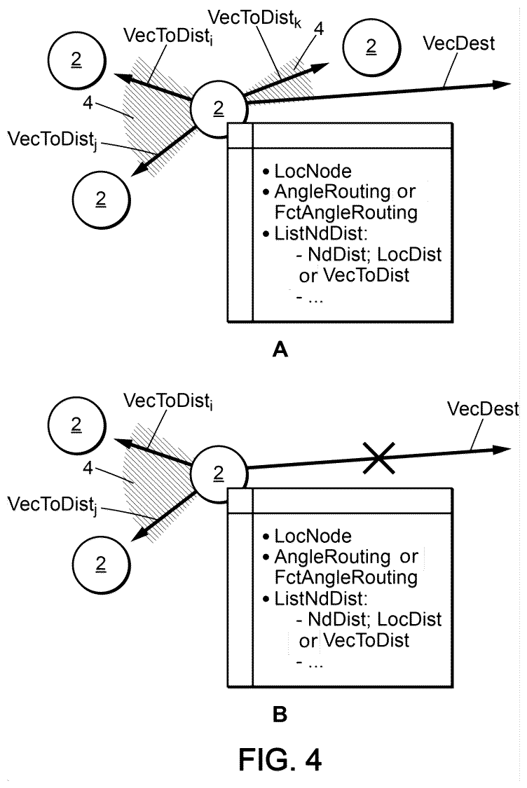

Alternatively, with reference to FIGS. 4A and 4B, the message may comprise an address of the sending node and the current node may comprise a table listing neighbour nodes of the current node, referred to as the neighbour table ListNdDist. The term “neighbour node” refers to nodes that are able to communicate directly with the current node. Each of the nodes in the neighbour table may be identified by an address NdDist. Each neighbour node is associated with data relating to the geographical location of the respective neighbour node. If the address of the sending node is present in the neighbour table, then the arrival vector VecArr is obtained on the basis of the neighbour table ListNdDist. More precisely, the arrival vector VecArr is obtained on the basis of the data relating to the geographical location of the neighbour node corresponding to the sending node.

The neighbour table thus makes it possible to construct a topology for message routing through a current node, which is a function of the neighbour nodes of this current node. Routing topology is understood in particular to mean the set of admissible directions for retransmission of a message by the current node according to the geographical position of the neighbour nodes of the current node.

A and B of FIG. 4 represent two examples of portions of a network comprising nodes 2 which include a current node and neighbour nodes: three neighbour nodes in FIG. 4A and two neighbour nodes in FIG. 4B. Said set of admissible directions is represented as hatched areas 4. With reference to FIG. 4A, the desired direction of transmission of the message is compatible with the routing topology of the current node: the message can be transmitted to the neighbour node concerned. With reference to FIG. 4B, the desired direction of transmission of the message is incompatible with the routing topology of the current node: the message is not retransmitted.

In addition, the data relating to the geographical location of the respective neighbour node may consist of a geographical location of the neighbour node LocDist or may correspond to a vector VecToDist that is collinear with the direction connecting the geographical location LocNode of the current node and the geographical location of the neighbour node.

It is preferred to store said vector VecToDist associated with the neighbour node, because this solution makes it possible to avoid calculating the vector between the sending node and the current node upon each new transmission of a message. Indeed, if the address of the sending node is present in the neighbour table, then the arrival vector VecArr is taken as being equal to the vector VecToDist associated with the neighbour node corresponding to the sending node.

The neighbour table may be built and updated progressively, as the current node receives messages from neighbour nodes.

The neighbour table may be used directly, or may be used only after a certain number of neighbour nodes are listed in the current node's neighbour table.

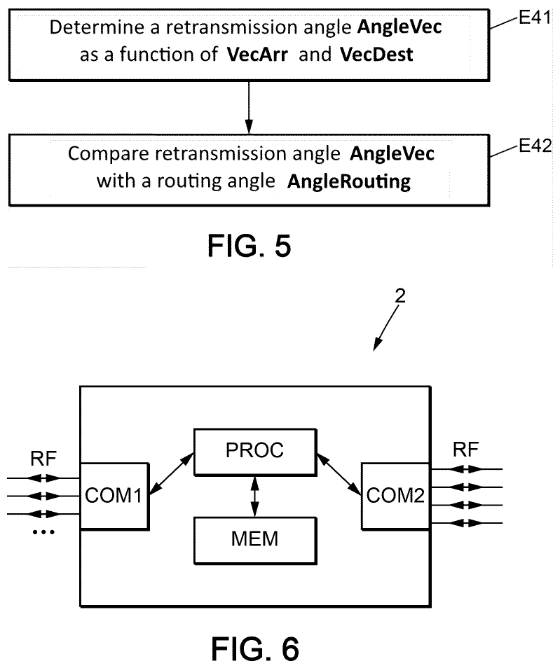

Furthermore, FIG. 5 represents an example of steps for implementing the decision step E4. In step E41, the current node determines a retransmission angle AngleVec as a function of the arrival vector VecArr and of the destination vector VecDest. In step E42, the current node then compares this retransmission angle AngleVec with a routing angle AngleRouting, and, based on this comparison, it is decided whether or not to transmit the message (in particular if the retransmission angle is greater than the routing angle as detailed further below).

The arrival vector VecArr may be obtained by the current node on the basis of the geographical location LocNode of the current node and of the geographical location LocSender of the sending node, when the message carries the geographical location LocSender of the sending node.

When the current node comprises the neighbour table ListNdDist and the message carries the address NdDist of the sending node, the arrival vector VecArr is obtained on the basis of the data relating to the geographical location of the corresponding neighbour node NdDist. As a reminder, this data may correspond to the geographical location of the neighbour node LocDist or may correspond to the vector VecToDist that is collinear with the direction connecting the geographical location LocNode of the current node and the geographical location of the neighbour node LocDist.

The retransmission angle AngleVec may in particular consist of an angle between the arrival vector VecArr and the destination vector VecDest, the arrival vector VecArr being obtained according to one of the means described above. Determination of the retransmission angle AngleVec may be achieved by a scalar product which is a simple operation that is inexpensive to perform.

In particular, if the retransmission angle AngleVec is greater than or equal to the routing angle AngleRouting, the message is retransmitted by the current node. Conversely, if the retransmission angle AngleVec is less than the routing angle AngleRouting, the message is not retransmitted by the current node. This makes it possible to avoid transmitting the message to nodes that are not located in the destination direction relative to the current node and therefore reduce or even prevent network saturation. In addition, this solution offers the advantage of making it possible to save energy and ensure network availability.

When the current node comprises the neighbour table ListNdDist, the retransmission angle AngleVec may be determined for each neighbour node NdDist listed in the neighbour table ListNdDist. When, for one of the neighbour nodes NdDist, the current node decides to retransmit the message after comparing the retransmission angle AngleVec with the routing angle AngleRouting, said neighbour node NdDist is added to a list of selected nodes ListNdSel. More precisely, when the retransmission angle AngleVec is greater than or equal to the routing angle AngleRouting for the respective neighbour node, this neighbour node NdDist is added to a list of selected nodes ListNdSel.

Next, the message is transmitted, for all neighbour nodes in the list of selected nodes ListNdSel. This feature makes it possible to improve efficiency in processing messages, by first performing, when appropriate, the selection of the neighbour nodes to which the message will be forwarded, and then, secondly, sending the messages to the selected neighbour nodes.

The routing angle AngleRouting is in particular fixed or is adapted according to the network topology, for example according to the extent and/or density of the network. The routing angle AngleRouting may have a different value for different nodes of the network, or alternatively may have the same value for all nodes of the network.

Furthermore, the routing angle AngleRouting may in particular be constant data at each node or may be data that is determinable according to at least one routing parameter, in particular carried by the message. To this end, the current node may comprise a function FctAngleRouting capable of determining the routing angle AngleRouting.

For example, the routing angle AngleRouting may be determined based on a number of hops NbHop of the message. To this end, the message may carry the parameter of the number of hops NbHop. The number of hops NbHop may be initialized to 0 or alternatively to a maximum number of hops. Then, the number of hops NbHop may be respectively incremented by 1 or decremented by 1 each time the message is retransmitted by a node. In particular, the greater or smaller the number of hops NbHop, depending on which implementation is used, the more the routing angle AngleRouting is reduced accordingly. This feature allows placing further constraints on the transmission of the message as it progresses through the network. In other words, the message is transmitted in an increasingly selective manner as it approaches the destination.

The routing angle AngleRouting may, for example, initially be set to 90°.

In addition, additional constraint parameters may be implemented in order to influence how the transmission of said message is controlled.

When the message comprises a number of hops NbHop, the node may decide whether or not to transmit the message based on the number of hops as well.

For example, when the number of hops NbHop is initialized to 0, the number of hops may be compared to a maximum number of hops NbHopMax, for example carried by the node or directly in the message. As long as the number of hops NbHop associated with the message is less than the maximum number of hops NbHopMax, the message may be retransmitted by the current node; otherwise the message is ignored. Alternatively, when the number of hops NbHop is initialized to a maximum number of hops, as long as the number of hops NbHop is not zero the message may be retransmitted by the current node; otherwise the message is ignored.

When the message comprises a number of hops NbHop, the method according to this disclosure may advantageously be implemented once the number of hops NbHop of the message reaches a predetermined number of hops since the first transmission of the message, for example two hops. In other words, the method further comprises, upon reception of the message and prior to implementing the transmission of the message, verifying the number of hops made by the message prior to reception of the message by the current node. When the number of hops made is equal to a predetermined number of hops, transmission of the message according to the method of this disclosure is implemented. This makes it possible to avoid being too restrictive at the initial transmission of the message and to be able, for example, to circumvent potential obstacles.

Each of the nodes may advantageously comprise a clock, in particular a synchronized clock. The clock makes it possible to implement a parameter that limits the lifetime of the message. In particular, the message may comprise an age AgeMsg. The decision on whether or not to transmit the message is made, in particular, based on the age of the message AgeMsg. More precisely, a lifetime AgeLimit is defined, carried by the message or specified in the current node. The age of the message AgeMsg is then compared to the lifetime AgeLimit. As long as the age of the message AgeMsg is less than the lifetime AgeLimit, the message may be retransmitted by the current node; otherwise, the message is ignored.

The message may also comprise a parameter relating to the urgency of the message. If the message is indicated as urgent, it may be processed by the current node according to a message priority protocol.

These parameters, namely the number of hops NbHop, the age of the message AgeMsg, and/or the urgency parameter of the message, may be initialized by the message sender or by the first node that sends the message in the network.

In addition, the node may comprise a table of processed messages TabMsg. Thus, when a message is transmitted to the current node, if this message is identified as being among the processed messages, the message will be ignored by the node; otherwise it will be processed by the current node. This preliminary step prevents a node from processing the same message multiple times.

The table of processed messages may preferably have a fixed size, and implement a FIFO (“First In First Out”) type of operation. Alternatively, the table of processed messages may be cleared out according to the age of the processed messages, when the age of the message is accessible data. Other operations of the table of processed messages may be envisaged.

In the event that the current node decides to transmit the message, the geographical location LocSender of the sending node is updated to the geographical location LocNode of the current node before the message is forwarded.

The network is preferably a mesh network, in particular a “crowd network” or a “disaster network”. In a mesh network, the nodes are connected peer-to-peer with no central hierarchy, each of the nodes being able to receive, send, and retransmit a message. In such a network, a message is thus transmitted by a source to arrive at a destination by being able to pass through intermediate nodes which receive and retransmit the message. In other words, the message can be transmitted from the source to the destination via nodes which do not have a direct communication link between them. The implementation of a mesh network makes it possible to increase network robustness by avoiding sensitive points where network operation may be disrupted in the event of a failure. Indeed, in a mesh network, if a node fails, the message can be transmitted via an alternative route.

Within the network, messages may be transmitted in flooding mode. In this transmission mode, a sending node sends a message without specifying the receiving node. Any listening node can thus receive the message and must process it. The message may then be forwarded in a similar manner. Message retransmission stops when the receiving node matches the specified destination node(s), or if other constraint parameters are met, for example if a maximum hop count for the message is reached.

Alternatively, messages may be transmitted using a point-to-point mode, commonly referred to as “peer-to-peer”. In this message transmission mode, a message is sent by a sending node but the addresses of the destination node(s) are specified. Any listening node can thus ignore the message if it is not included in the destination node(s). In peer-to-peer mode, the routes are predefined. The network must then provide seamless connections, or, alternatively, alternative routes may be provided.

In the remainder of the description, a node will be described in more detail, it being possible to apply the described technical features to all nodes of the network. The node is typically a small device that consumes little power.

FIG. 6 illustrates one of the nodes in the network. The node comprises a processor PROC and a memory MEM storing at least the instructions of a computer program and accessible by the processor in order to implement the method as described above when the processor PROC executes the instructions of the program. The memory MEM of the node notably comprises random access memory and storage memory.

The node memory MEM stores the geographical location LocNode of the respective node as well as the routing angle AngleRouting or the function for determining the routing angle.

Where appropriate, the node memory may store the neighbour table ListNdDist, the table of processed messages, and/or additional constraint parameters such as the maximum number of hops NbHopMax, the message lifetime AgeLimit, or a parameter relating to the urgency of the message. The table of processed messages may in particular be stored in non-volatile memory of the node, namely flash memory or a hard disk, depending on network requirements.

Furthermore, the node comprises, in particular, a first communication interface COM1 controlled by the processor PROC, for receiving and transmitting messages from and to other nodes of the network, in particular neighbour nodes of the node in question. The first communication interface COM1 is controlled by the processor.

The node may comprise a second communication interface COM2 controlled by the processor PROC, for receiving and transmitting routing data from and to other nodes of the network.

The first and second communication interfaces may, in particular, be the same.

Each of the first and second communication interfaces COM1 and COM2 may preferably consist of a radiofrequency-based communication interface RF, enabling the nodes to communicate with each other without going through a central system. By way of non-limiting example, the communication interface may comply with 2G, 3G, 4G or 5G standards according to 3GPP. Low-power communication interfaces may in particular be preferred, such as Lora, BLE or SigFox. Other D2D (“Device to Device”) communication interfaces using 6G may also be considered in the future, provided that the cost and energy consumption constraints so allow.

In addition, at least some nodes may comprise external sensors that can generate messages to be transmitted over the network (environmental sensors, meters).

Each node may further comprise power supply means, for example a battery, a wired power supply, solar panels, or a combination of these power supply means.

1. A routing method for routing a message via nodes of a network, wherein the message comprises geographical destination data, and the method, implemented by a current node of the network, comprises:
upon receiving a message comprising said geographical destination data, and coming from a sending node,
deciding whether or not to transmit the message on the basis of a desired direction of transmission of the message, determined on the basis of the geographical destination data and of a direction taken by the message between the sending node and the current node.

2. The routing method according to claim 1, comprising:
determining the desired direction of transmission of the message, which comprises determining a destination vector that is collinear with the direction connecting a geographical location of the current node and the geographical destination,
determining the direction taken by the message, which comprises obtaining an arrival vector that is collinear with the direction connecting the geographical location of the current node and the geographical location of the sending node.

3. The routing method according to claim 2, wherein deciding (E4) whether or not to transmit the message comprises: comparing a retransmission angle determined as a function of the arrival vector and the destination vector, with a routing angle.

4. The routing method according to claim 3, wherein the routing angle is constant data.

5. The routing method according to claim 3, wherein the routing angle is data that can be determined as a function of at least one routing parameter carried by the message.

6. The routing method according to claim 1, wherein the message carries a geographical location of the sending node.

7. The routing method according to claim 1, wherein the message carries an address of the sending node and the current node comprises a table, referred to as the neighbour table, which lists the neighbour nodes of the current node, each neighbour node being identified by an address and each neighbour node being associated with data relating to a geographical location of that neighbour node, the arrival vector being obtained on the basis of the neighbour table when the address of the sending node is present in the neighbour table.

8. The routing method according to claim 1, wherein the sending node is the last node to have transmitted the message to the current node.

9. The routing method according to claim 1, wherein the message comprises a number of hops, and the decision on whether or not to transmit the message is further made based on the number of hops.

10. The routing method according to claim 9, wherein the method is implemented once the number of hops of the message reaches a predetermined number of hops since the first transmission of the message.

11. The routing method according to claim 1, wherein the message comprises an age, and the decision on whether or not to transmit the message is made based on the age of the message.

12. A node of a network, configured for implementing the method according to claim 1.

13. A non-transitory computer-readable medium storing instructions that, when executed by at least one processor, cause said at least one processor to implement the method according to claim 1.
